(19) United States
(12) Patent Application Publication
(10) Pub. No.: US 2026/0078644 A1
(43) Pub. Date: Mar. 19, 2026

(54) DEBRIS REMOVAL FROM DEGASSER PROBE

(71) Applicant: Schlumberger Technology Corporation, Sugar Land, TX (US)

(72) Inventors: Chiraz Belhadj, Clamart (FR); Emilie Colombel, Clamart (FR); David Seevagen, Elancourt (FR)

(21) Appl. No.: 18/884,439

(22) Filed: Sep. 13, 2024

(51) Int. Cl. E21B 21/06; B01D 19/00; B01D 29/075; B01D 29/64

(52) U.S. Cl. CPC E21B 21/067; B01D 19/00; B01D 29/075; B01D 29/6476; E21B 21/065; B01D 2201/204; B01D 2201/313

(57) ABSTRACT

Devices, systems, and methods for debris removal from a degasser probe are described herein. In some examples, one or more embodiments include a degasser probe comprising a suction head to receive drilling fluid and cause the drilling fluid to be transmitted to a degasser during a drilling operation, a strainer screen located upstream of the suction head to filter the drilling fluid during the drilling operation, and a worm screw located proximate to the strainer screen, where the worm screw is axially rotatable to remove debris from the strainer screen during the drilling operation.

### BACKGROUND

Wellbores may be drilled into a surface location or seabed for a variety of exploratory or extraction purposes. For example, a wellbore may be drilled to access fluids, such as liquid and/or gaseous hydrocarbons, stored in subterranean formations and to extract the fluids from the formations. Wellbores used to produce or extract fluids may be lined with casing around the walls of the wellbore. A variety of drilling methods may be utilized depending partly on the characteristics of the formation through which the wellbore is drilled.

A drilling system can provide weight on the bit using one or more drill collars positioned in a bottom hole assembly near the bit. Bottom hole assemblies can also include communication devices to transmit information about the bit and other downhole parameters to receiving devices uphole from the bit.

### BRIEF DESCRIPTION OF THE DRAWINGS

FIG. 1 is an example schematic representation of a drilling system, in accordance with one or more embodiments of the present disclosure.

FIG. 2 is a perspective view of an example of a degasser probe strainer assembly for use in a drilling system, in accordance with one or more embodiments of the present disclosure.

FIG. 3 is a perspective view of an example of a worm screw for use with a degasser probe, in accordance with one or more embodiments of the present disclosure.

FIG. 4A is a side view of an example of a degasser probe strainer assembly, in accordance with one or more embodiments of the present disclosure.

FIG. 4B is a front view of an example of a strainer screen having a slot, in accordance with one or more embodiments of the present disclosure.

FIG. 5 is a perspective view of an example of a degasser probe having a protective cage for use in a drilling system, in accordance with one or more embodiments of the present disclosure.

FIG. 6 is a perspective section view of an example of a degasser probe strainer assembly having a protective cage for use in a drilling system, in accordance with one or more embodiments of the present disclosure.

### DETAILED DESCRIPTION

Drilling operations for fluids such as liquid and/or gaseous hydrocarbons can utilize a drilling system to drill a wellbore to locate such fluids. During such drilling operations, gas may be entrained into the drilling fluid. This gas may be transported from the wellbore to the surface through the drilling fluid. In some examples, such gas may removed for sampling. However, this gas being present in the drilling fluid may cause a reduction in hydrostatic pressure in the drilling system.

Samples and/or other removal of this gas may be performed using a degasser. As used herein, a degasser can be a device to remove entrained gas from a drilling fluid. The drilling fluid may be provided to the degasser by a degasser probe. As used herein, a degasser probe can be a device that transports drilling fluid to a degasser. For example, the degasser probe can utilize a pump to generate a negative pressure to transport (e.g., via suction) drilling fluid to the degasser.

During drilling operations, a drill bit can drill an earth formation to locate and/or access fluids mentioned above. In some examples, debris from drilling the earth formation (e.g., cuttings) may be intermixed with the drilling fluid. Accordingly, the degasser probe can include a strainer screen to filter debris from the drilling fluid as the drilling fluid is retrieved by the degasser probe. Filtering the debris from the drilling fluid is important to prevent the debris from entering the degasser, as the debris can be abrasive and cause damage to upstream systems.

However, debris can get stuck near the strainer screen as drilling fluid is retrieved by the degasser probe. For example, debris may become stuck on the strainer screen due to the suction of the degasser probe. Previous approaches to removing the debris utilized rectangular cutter blade located proximate to the strainer screen that rotated to clear debris. However, due to the shape of the cutter blade, debris could remain in contact with the strainer screen. Additionally, in some instances, debris could get stuck between the cutter blade and the strainer screen, preventing the cutter blade from rotating altogether. Further, due to previous designs, the drilling fluid would flow towards the strainer screen axially and radially, reducing the effectiveness of the cutter blade removing debris from the degasser probe. In these cases, drilling operations would have to be stopped while a user (e.g., maintenance personnel) retrieved the degasser probe and manually removed debris from the degasser probe, resulting in downtime.

Debris removal from degasser probe, according to the disclosure, can allow for a degasser probe having a rotatable worm screw to remove debris from a strainer screen of the degasser probe. The worm screw can include blades which can cause debris located proximate to the strainer screen to be moved away from the strainer screen, preventing such debris from becoming stuck on the strainer screen or between the worm screw and the strainer screen. Additionally, an annular bumper and/or a protective cage located on the degasser probe can encourage axial flow of the drilling fluid towards the strainer screen, increasing the effectiveness of the worm screw in removal of debris from the strainer screen as compared with previous approaches. Accordingly, the degasser probe with the rotatable worm screw can reduce maintenance and degasser downtime, as compared with previous approaches.

In the following description, numerous details are set forth to provide an understanding of some embodiments of the present disclosure. It is to be understood that the following disclosure provides many different embodiments, or examples, for implementing different features of various embodiments. Specific examples of components and arrangements are described below to simplify the disclosure. These are merely examples and are not intended to be limiting. However, it will be understood by those of ordinary skill in the art that the system and/or methodology may be practiced without these details and that numerous variations or modifications from the described embodiments are possible. This description is not to be taken in a limiting sense, but rather made merely for the purpose of describing general principles of the implementations. The scope of the described implementations should be ascertained with reference to the issued claims.

As used herein, the terms “connect”, “connection”, “connected”, “in connection with”, and “connecting” are used to mean “in direct connection with” or “in connection with via one or more elements”; and the term “set” is used to mean “one element” or “more than one element”. Further, the terms “couple”, “coupling”, “coupled”, “coupled together”, and “coupled with” are used to mean “directly coupled together” or “coupled together via one or more elements”. As used herein, the terms “up” and “down”; “upper” and “lower”; “top” and “bottom”; and other like terms indicating relative positions to a given point or element are utilized to more clearly describe some elements. Commonly, these terms relate to a reference point at the surface from which drilling operations are initiated as being the top point and the total depth being the lowest point, wherein the well (e.g., wellbore, borehole) is vertical, horizontal or slanted relative to the surface.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately,” “about,” “generally,” and “substantially” may refer to an amount that is within less than 10% of, within less than 5% of, within less than 1% of, within less than 0.1% of, and/or within less than 0.01% of the stated amount. As another example, in certain embodiments, the terms “generally parallel” and “substantially parallel” or “generally perpendicular” and “substantially perpendicular” refer to a value, amount, or characteristic that departs from exactly parallel or perpendicular, respectively, by less than or equal to 15 degrees, 10 degrees, 5 degrees, 3 degrees, 1 degree, or 0.1 degree.

These embodiments are described in sufficient detail to enable those of ordinary skill in the art to practice one or more embodiments of this disclosure. It is to be understood that other embodiments may be utilized and that process, electrical, and/or structural changes may be made without departing from the scope of the present disclosure.

As will be appreciated, elements shown in the various embodiments herein can be added, exchanged, combined, and/or eliminated so as to provide a number of additional embodiments of the present disclosure. The proportion and the relative scale of the elements provided in the figures are intended to illustrate the embodiments of the present disclosure and should not be taken in a limiting sense.

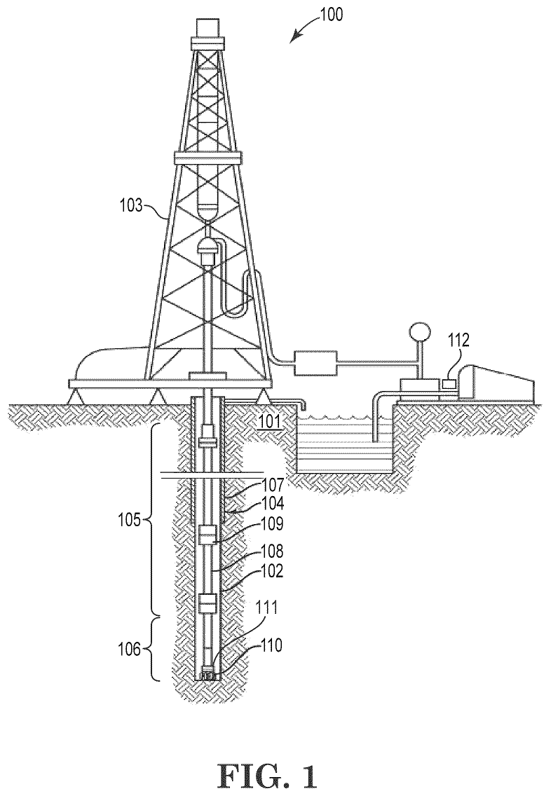

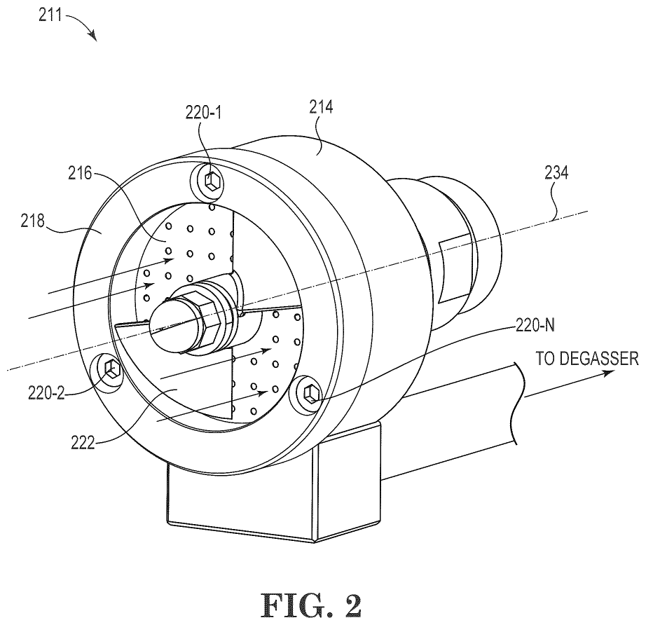

The figures herein follow a numbering convention in which the first digit or digits correspond to the drawing figure number and the remaining digits identify an element or component in the drawing. Similar elements or components between different figures may be identified by the use of similar digits. For example, 111 may reference element “11” in FIG. 1, and a similar element may be referenced as 211 in FIG. 2.

As used herein, “a”, “an”, or “a number of” something can refer to one or more such things, while “a plurality of” something can refer to more than one such things. For example, “a number of components” can refer to one or more components, while “a plurality of components” can refer to more than one component.

FIG. 1 is an example schematic representation of a drilling system 100, in accordance with one or more embodiments of the present disclosure. The drilling system 100 includes a drill rig 103 used to turn a drilling tool assembly 104 which extends downward into the wellbore 102. The drilling tool assembly 104 may include a drill string 105, a bottom hole assembly 106, and a bit 110 attached to the downhole end of the drill string 105.

The drill string 105 may include several joints of drill pipe 108 connected end-to-end through tool joints 109. The drill string 105 transmits drilling fluid through a central bore and transmits rotational power from the drill rig 103 to the bottom hole assembly 106. In some embodiments, the drill string 105 may further include additional components such as subs, pup joints, etc. The drill pipe 108 provides a hydraulic passage through which drilling fluid is pumped from the surface. The drilling fluid discharges through selected-size nozzles, jets, or other orifices in the bit 110 for the purposes of cooling the bit 110 and cutting structures thereon, and for lifting cuttings out of the wellbore 102 as it is being drilled.

The bottom hole assembly 106 may include the bit 110 or other components. An example bottom hole assembly 106 may include additional or other components (e.g., coupled between to the drill string 105 and to the bit 110). Examples of additional bottom hole assembly 106 components include a degasser probe, drill collars, stabilizers, measurement-while-drilling (“MWD”) tools, logging-while-drilling (“LWD”) tools, rotary steerable system (“RSS”) tools, sensor(s), downhole motors, steering tools, underreamers, section mills, hydraulic disconnects, jars, vibration or dampening tools, other components, and/or combinations thereof.

In general, the drilling system 100 may include other drilling components and accessories, such as special valves (e.g., Kelly cocks, blowout preventors, and safety valves). Additional components included in the drilling system 100 may be considered a part of the drilling tool assembly 104, the drill string 105, or a part of the bottom hole assembly 106 depending on their locations in the drilling system 100.

The bit 110 in the bottom hole assembly 106 may be any type of bit suitable for degrading downhole materials. For instance, the bit 110 may be a drill bit suitable for drilling the earth formation 101. Example types of drill bits used for drilling earth formations are fixed-cutter or drag bits. In other embodiments, the bit 110 may be a mill used for removing metal, composite, elastomer, other materials downhole, and/or combinations thereof. For instance, the bit 110 may be used with a whipstock to mill into casing 107 lining the wellbore 102. The bit 110 may also be a junk mill used to mill away tools, plugs, cement, other materials within the wellbore 102, and/or combinations thereof. Swarf or other cuttings formed by use of a mill may be lifted to the surface or may be allowed to fall downhole.

As mentioned above, the bottom hole assembly 106 can include a degasser probe 111. The degasser probe 111 can transport drilling fluid to a degasser 112. The degasser 112 can remove entrained gas from the drilling fluid retrieved by the degasser probe 111. The degasser probe 111 can include a suction head, a strainer screen, and a worm screw to filter and transport the drilling fluid to the degasser 112, as is further described herein.

FIG. 2 is a perspective view of an example of a degasser probe 211 strainer assembly for use in a drilling system, in accordance with one or more embodiments of the present disclosure. As illustrated in FIG. 2, the degasser probe 211 can include a suction head 214, a strainer screen 216, and a worm screw 222.

As previously mentioned above, the degasser probe 211 can be utilized to retrieve drilling fluid for gas sampling and/or removal from the drilling fluid. The degasser probe 211 can include the suction head 214 to receive drilling fluid and cause drilling fluid to be transmitted to a degasser during a drilling operation. As used herein, the term “suction head” refers to a structure to channel fluid from an input location to an output location. For example, the suction head 214 can receive drilling fluid (e.g., as illustrated by the arrows in FIG. 2) and cause the drilling fluid to be directed towards the degasser. A pump (e.g., not illustrated in FIG. 2) can generate a negative pressure to transport (e.g., via suction) the drilling fluid to the degasser.

The degasser probe 211 further includes a strainer screen 216. As used herein, the term “strainer screen” refers to a device which arrest solids in a flowing liquid. The strainer screen 216 can be a plate with perforations that allow a flowing liquid through (e.g., drilling fluid), but solids which are too large to pass through the perforations are blocked by the plate from passing. The strainer screen 216 can be located upstream of the suction head 214. The strainer screen 216 can therefore filter the drilling fluid during drilling operations by stopping debris, such as cuttings from drilling operations, from being transported upstream towards the degasser. Preventing such debris from moving upstream from the degasser probe 211 can prevent damage to upstream systems due to the abrasive qualities of such debris.

The degasser probe 211 can further include a worm screw 222. As used herein, the term “worm screw” refers to a device that imparts feed motion. The worm screw 222 can be located proximate to the strainer screen 216, as is further described herein. The worm screw 222 can further be coaxially located with and upstream of the strainer screen 216. The worm screw 222 is axially rotatable to remove debris from the strainer screen 216 during drilling operations. For example, debris can be caught by the strainer screen 216. However, due to the suction generated by the degasser probe 211, the debris does not leave the strainer screen 216.

The worm screw 222 can axially rotate to impart a worm motion on the debris at the strainer screen 216, causing the debris to be removed from the strainer screen 216. For example, the worm screw 222 can rotate axially (e.g., in a counterclockwise direction, as oriented in FIG. 2) so that the worm screw 222 lifts debris from the strainer screen 216 and directs it in an axial direction (e.g., away from the strainer screen 216) during drilling operations, as is further described herein.

As illustrated in FIG. 2, the degasser probe 211 can further include an annular bumper 218. As used herein, the term “bumper” refers to a device to protect another device from damage and to direct debris in a particular direction. The annular bumper 218 can be located coaxially with and upstream from the strainer screen 216. The annular bumper 218 can axially direct drilling fluid towards the strainer screen 216 during drilling operations. The annular bumper can be connected to an external radial edge portion of the suction head 214 in order to cause drilling fluid to approach the strainer screen 216 in a substantially axial manner (e.g., substantially parallel with the longitudinal axis 234). The annular bumper 218 can prevent debris located in drilling fluid radially approaching the strainer screen 216 from contacting the strainer screen 216. The annular bumper 218 can therefore assist in directing the drilling fluid (e.g., and debris located therein) to approach the strainer screen 216 in a substantially axial manner, which can increase the efficiency of debris removal from the strainer screen 216 by the worm screw 222 as compared with previous approaches.

As illustrated in FIG. 2, the annular bumper 218 can radially encompass the worm screw 222. The annular bumper 218 is shaped such that the entire circumference of the annular bumper 218 encompasses the entirety of the worm screw 222. For example, the annular bumper 218 entirely surrounds the worm screw 222 radially such that the worm screw 222 is located entirely within the circumference of the annular bumper 218.

Additionally, the annular bumper 218 can axially encompass the worm screw 222. For example, the annular bumper 218 can include a height (e.g., in an axial direction) such that the worm screw 222 is located entirely within the height of the of the annular bumper 218. That is, the worm screw 222 does not extend above the height of the annular bumper 218.

The annular bumper 218 radially and axially encompassing the worm screw 222 can allow for more efficient debris removal from the strainer screen 216. For example, as mentioned above, the annular bumper 218 can prevent debris located in drilling fluid from radially approaching and contacting the strainer screen 216, and rather encourage the drilling fluid (e.g., and any debris located therein) to approach the strainer screen 216 in a substantially axial manner, where the worm screw 222 can more easily remove the debris from the strainer screen 216 as compared with previous approaches with debris approaching the strainer screen 216 from both radial and axial directions.

As mentioned above, the annular bumper 218, the worm screw 222, the strainer screen 216, and the suction head 214 can be coaxially located with respect to each other. Additionally, the annular bumper 218 and the strainer screen 216 can be connected to the suction head 214 via a plurality of fasteners 220-1, 220-2, 220-N. The annular bumper 218 can spread stress concentration away from the strainer screen 216 caused by the fasteners 220-1, 220-2, 220-N, which can help prevent damage to the strainer screen 216 during assembly during manufacturing and/or maintenance.

In some examples, the annular bumper 218, the worm screw 222, and the strainer screen 216 can include an anti-friction and/or anti-adherent coating. The anti-friction and/or anti-adherent coating can optimize friction between surfaces that directly contact each other during drilling operations, reducing wear on the components. For example, the anti-friction and/or anti-adherent coating can reduce friction between the worm screw 222 and the strainer screen 216 (e.g., as the worm screw 222 directly contacts the strainer screen 216) and between the worm screw 222 and the annular bumper 218, as the worm screw 222 can be in direct contact with the annular bumper 218.

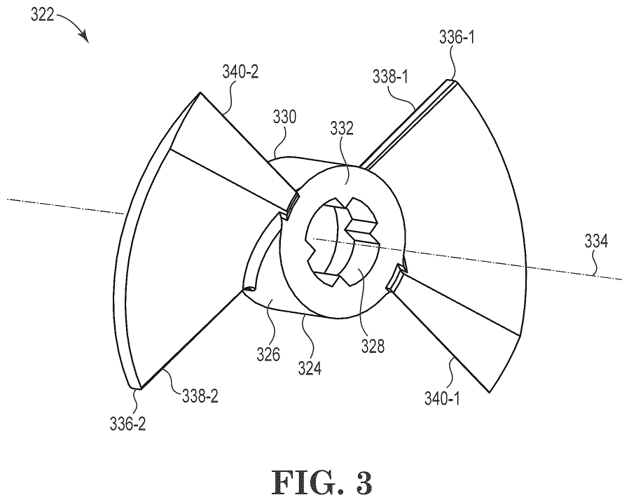

FIG. 3 is a perspective view of an example of a worm screw 322 for use with a degasser probe, in accordance with one or more embodiments of the present disclosure. The worm screw 322 can be utilized to remove debris from a strainer screen of a degasser probe, as previously described in connection with FIG. 2.

As previously mentioned in connection with FIG. 2, the worm screw 322 can impart a feed motion on debris at a strainer screen. In order to accomplish this, the worm screw 322 can be comprised of various parts including a central body 324 and a plurality of blades 336, as is further described herein.

The central body 324 can include an outer surface 326, an inner surface 328, a first end surface 330, and a second end surface 332. The first end surface 330 can be located proximate to the strainer screen (e.g., when the worm screw 322 is assembled on the degasser probe). For example, the first end surface 330 can be in contact with the strainer screen when the worm screw 322 is assembled on the degasser probe.

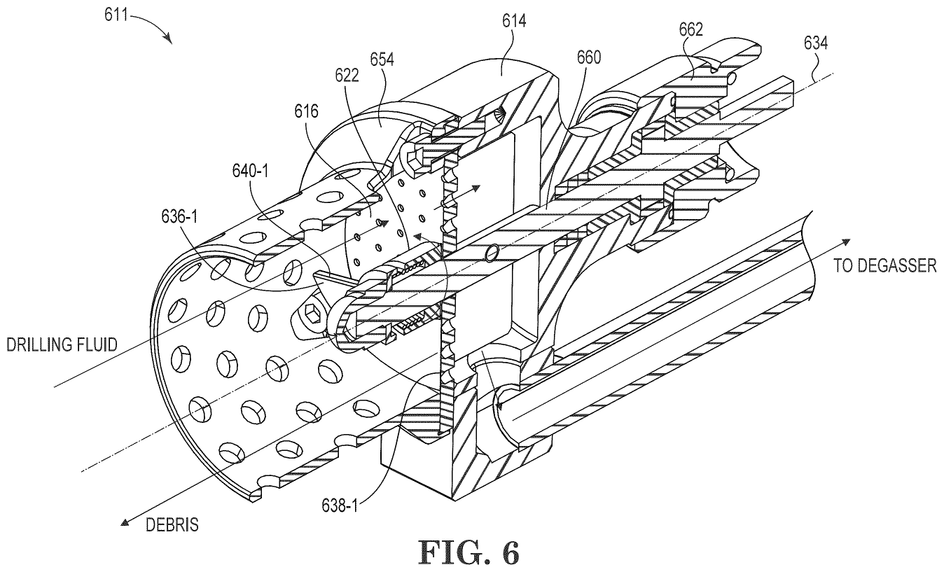

The inner surface 328 can define an opening through the central body 324. Although not illustrated in FIG. 3, the opening through the central body 324 can be shaped to receive a drive shaft to cause the worm screw 322 to rotate to lift debris from the strainer screen during drilling operations, as is further described in connection with FIG. 6. Additionally, the longitudinal axis 334 can run through the center of the opening through the central body 324.

The worm screw 322 can further include a plurality of blades 336-1, 336-2 extending outwardly from the outer surface 326 of the central body 324. As used herein, the term “blade” refers to a device having a plate configured to direct material in a particular direction. The plurality of blades 336-1, 336-2 can be shaped (e.g., as is further described herein) in order to impart a substantially axial motion on debris located proximate to the strainer screen in order to remove the debris from the strainer screen, as is further described in connection with FIG. 6.

The plurality of blades 336-1, 336-2 can extend outwardly from the outer surface 326 and collectively contact an entirety of the outer surface 326 between the first end surface 330 and the second end surface 332. For example, each blade 336 can extend outwardly from the outer surface 326 along the entirety of the outer surface 326 axially in a direction of the longitudinal axis 334 so that each blade 336 extends outwardly the entire height of the outer surface 326 between the first end surface 330 and the second end surface 332.

As illustrated in FIG. 3, each blade 336 is flighted in a partial helix around the longitudinal axis 334. As used herein, the term “helix” refers to a curve shape with tangent lines at a constant angle to a fixed axis. Each blade 336 can be flighted in a partial helix around the longitudinal axis 334 such that each blade 336-1, 336-2 extends radially from the outer surface 326 but for less than a complete turn around the longitudinal axis 334. For example, each blade 336-1, 336-2 can be shaped so as to make less than a 360° turn around the longitudinal axis 334.

For instance, the first blade 336-1 can be flighted in a first partial helix, and the second blade 336-2 can also be flighted in a second partial helix. Collectively, the first blade 336-1 and the second blade 336-2 can form a partial double helix around the longitudinal axis 334. As used herein, the term “double helix” refers to two helices with the same axis differing by a translation along the axis. For example, the first blade 336-1 and the second blade 336-2 can form a partial double helix where the partial double helix is less than a complete turn around the shared longitudinal axis 334. For example, each blade 336-1, 336-2 can be shaped so as to make less than a 360° turn around the longitudinal axis 334.

As illustrated in FIG. 3, the plurality of blades 336 can include a curved shape (e.g., concave as viewed in FIG. 3). However, examples of the disclosure are not so limited. For instance, the plurality of blades 336 can include a straight shape or a concave shape.

Each blade 336-1, 336-2 can include a first edge 338 and a second edge 340, respectively. For example, blade 336-1 can include a first edge 338-1 located proximate to the first end surface 330 and the strainer screen (e.g., when connected to the degasser probe) and a second edge 340-1 located proximate to the second end surface 332. Additionally, blade 336-2 can include a first edge 338-2 located proximate to the first end surface 330 and the strainer screen (e.g., when connected to the degasser probe) and a second edge 340-2 located proximate to the second end surface 332.

During drilling operations, the worm screw 322 can axially rotate about the longitudinal axis 334 in a direction such that the first edges 338-1, 338-2 function as leading edges and the second edges 340-1, 340-2, function as trailing edges. As oriented in FIG. 3, the worm screw 322 can axially rotate in a counterclockwise direction about the longitudinal axis 334. As such, the first edges 338-1, 338-2 are the edges closest to the direction of travel and the second edges 340-1, 340-2 are the edges farthest from the direction of travel.

Accordingly, the first edges 338-1, 338-2 being directly proximate to the strainer screen (e.g., in contact with the strainer screen when the worm screw 322 is connected to the degasser probe) are first in contact with debris on the strainer screen when the worm screw 322 is rotated and are configured to lift the debris from the strainer screen during the drilling operation. This lifting can be caused by the first edges 338-1, 338-2 to occur in a substantially axial direction along the longitudinal axis 334, causing the debris to be moved away from the strainer screen in a feed motion caused by the worm screw 322, as is further described in connection with FIG. 6.

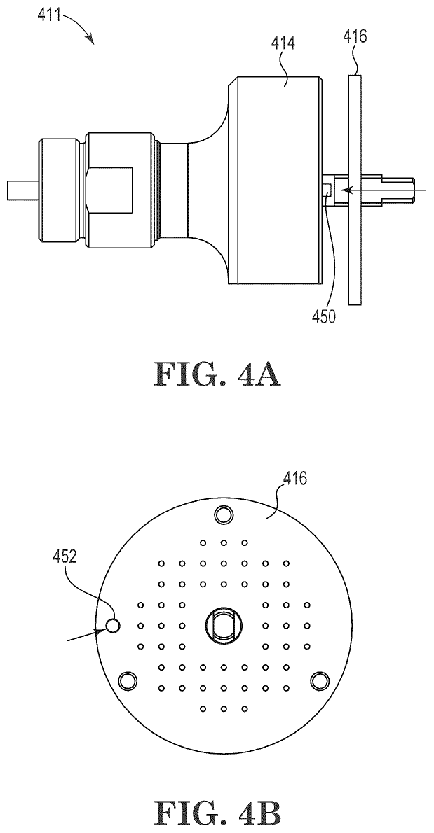

FIG. 4A is a side view of an example of a degasser probe strainer assembly 411, in accordance with one or more embodiments of the present disclosure. As previously described in connection with FIG. 2, the degasser probe 411 can include the suction head 414 and the strainer screen 416.

The suction head 414 can further include an extension member 450. As used herein, the term “member” refers to a constituent part of a structural whole. For example, the extension member 450 can be an extension of material of the suction head 414. As illustrated in FIG. 4, the extension member 450 can be a circular shape extending from a surface of the suction head 414 facing the strainer screen 416.

The extension member 450 can be configured to interface with a slot on the strainer screen 416. The interface between the extension member 450 and the slot on the strainer screen 416 can ensure that the strainer screen 416 can only be attached to the suction head 414 in a single orientation, as is further described in connection with FIG. 4B.

FIG. 4B is a front view of an example of a strainer screen 416 having a slot 452, in accordance with one or more embodiments of the present disclosure. The strainer screen 416 can be connected to the suction head 414.

As mentioned above, the strainer screen 416 can include the slot 452. As used herein, the term “slot” refers to an opening in a material. The slot 452 can be an opening in the strainer screen 416. In some examples, the slot 452 does not extend through an entirety of the strainer screen 416 so that liquid and/or debris is not able to pass through the slot 452.

The slot 452 can be complementarily shaped in order to receive the extension member 450 protruding from the suction head 414. For example, the slot 452 can be circularly shaped in order to receive the circular shaped extension member 450.

The slot 452 and the extension member 450 can function as a mechanism to ensure that the strainer screen 416 is only able to be connected to the suction head 414 in a single orientation. The perforations through the strainer screen 416 can be shaped in order to promote flow of fluids through the strainer screen 416 in a particular direction. Therefore, if the strainer screen 416 is connected to the suction head 414 upside down, the strainer screen 416 will not perform efficiently and/or effectively. Therefore, the slot 452 and the extension member 450 can function as a poka-yoke safeguard to ensure that the strainer screen 416 is connected to the suction head 414 in the correct orientation during manufacturing and/or maintenance periods.

While the extension member 450 and slot 452 are described above as being complimentarily circularly shaped, examples of the disclosure are not so limited. For example, the extension member 450 may be in a square, rectangular, triangular, star, and/or any other shape, and the slot 452 may be complimentarily shaped to the shape of the extension member 450.

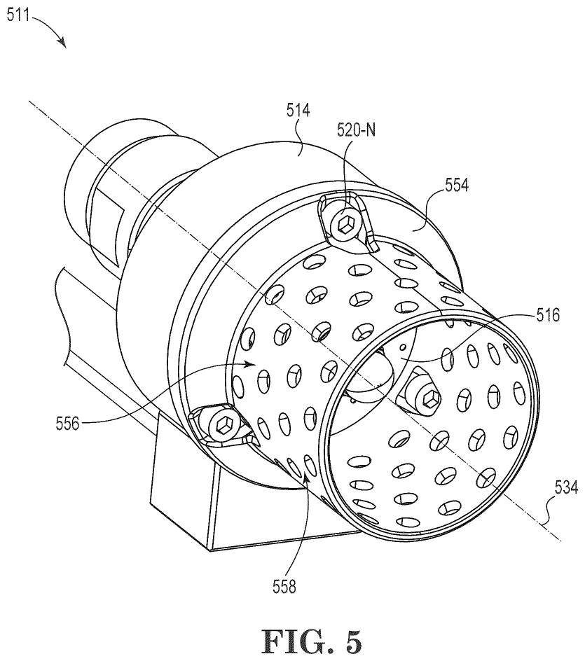

FIG. 5 is a perspective view of an example of a degasser probe 511 having a protective cage 554 for use in a drilling system, in accordance with one or more embodiments of the present disclosure. As previously described, the degasser probe 511 can include a suction head 514, a strainer screen 516, and a worm screw (e.g., not illustrated in FIG. 5).

As illustrated in FIG. 5, in some examples, the degasser probe 511 can include a protective cage 554. As used herein, the term “cage” refers to a protective enclosure. For example, the protective cage 554 can be located coaxially with and upstream from the strainer screen 516. The protective cage 554 can be connected to the suction head 514 and extend in a direction along the longitudinal axis 534 of the central body of the worm screw.

The protective cage 554 and the strainer screen 516 can be connected to the suction head 514 via a plurality of fasteners 520-N. The protective cage 554 can spread stress concentration away from the strainer screen 516 caused by the fasteners 520-N, which can help prevent damage to the strainer screen 516 during assembly during manufacturing and/or maintenance. The protective cage 554 can include an anti-friction and/or anti-adherent coating.

The protective cage 554 can cause the drilling fluid to approach the strainer screen 516 in a substantially axial manner and pre-filter debris from the drilling fluid before the drilling fluid reaches the strainer screen 516, as is further described in connection with FIG. 6.

FIG. 6 is a perspective section view of an example of a degasser probe 611 strainer assembly having a protective cage 654 for use in a drilling system, in accordance with one or more embodiments of the present disclosure. As previously described, the degasser probe 611 can include a suction head 614, a strainer screen 616, and a worm screw 622.

As previously described in connection with FIG. 2, the degasser probe 611 can include a suction head 614 to receive drilling fluid and cause the drilling fluid to be transmitted to the degasser during drilling operations. For example, as illustrated in FIG. 6, the suction head 614 can receive drilling fluid through the strainer screen 616 and direct the drilling fluid out of the suction head 614 towards the degasser.

The strainer screen 616 can be located coaxially with and upstream of the suction head 614. The strainer screen 616 can filter the drilling fluid during the drilling operations.

The worm screw 622 can be located coaxially with and upstream of the strainer screen, and can include a plurality of blades 636. In the section view of FIG. 6, the blade 636-1 of the plurality of blades 636 is shown and can include the first edge 638-1 located proximate to the strainer screen 616 and the first end surface of the central body of the worm screw 622. Additionally, the blade 636-1 can include the second edge 640-1 located proximate to the second end surface of the central body of the worm screw 622.

As previously described in connection with FIG. 5, the degasser probe 611 further includes a protective cage 654 connected to the suction head 614 and extending in a direction along the longitudinal axis 634 of the central body of the worm screw 622. The protective cage 654 can radially and axially encompass the worm screw 622 (e.g., similar to the annular bumper described in connection with FIG. 2) and can allow for more efficient debris removal from the strainer screen 616. For example, the protective cage 654 can prevent debris located in drilling fluid from radially approaching and contacting the strainer screen 616, and rather encourage the drilling fluid (e.g., and any debris located therein) to approach the strainer screen 616 in a substantially axial manner, where the worm screw 622 can more easily remove the debris from the strainer screen 616 as compared with previous approaches with debris approaching the strainer screen 616 from both radial and axial directions.

As illustrated in FIG. 6, the protective cage 654 can include a non-perforated portion 656 located proximate to the strainer screen 616. The non-perforated portion 656 can be configured to axially direct drilling fluid towards the strainer screen 616 during drilling operations. Additionally, the protective cage 654 can include a perforated portion 658 to pre-filter the drilling fluid before the drilling fluid reaches the strainer screen 616.

The degasser probe 611 can further include a drive shaft 660. The drive shaft 660 can be located in the opening through the central body of the worm screw 622 and can be connected to a motor 662. The drive shaft 660 can cause the worm screw 622 to rotate during drilling operations, as is further described herein.

For example, during drilling operations, drilling fluid can be drawn towards the degasser probe 611 via negative pressure generated by a pump (e.g., not illustrated in FIG. 6). As the drilling fluid approaches the degasser probe 611, the perforated portion 658 of the protective cage 654 can pre-filter the drilling fluid. For example, debris that is larger than the perforations through the perforated portion 658 that enter the protective cage 654 radially can be filtered before they reach the strainer screen 616.

The protective cage 654 can axially direct the drilling fluid towards the strainer screen 616. As drilling fluid encounters the strainer screen 616, debris located in the drilling fluid can be stopped by the strainer screen 616.

The drive shaft 660 can cause the worm screw 622 to axially rotate about the longitudinal axis 634. As the worm screw 622 rotates (e.g., counterclockwise as oriented in FIG. 6), the first edge 638-1 functions as a leading edge and when the first edge 638-1 contacts debris located on the strainer screen 616, the first blade 636-1 of the plurality of blades 636 is configured to lift the debris from the strainer screen 616 in a substantially axial direction along the longitudinal axis 634, causing the debris to be moved away from the strainer screen 616 in a feed motion caused by the worm screw 622. The second blade (e.g., not illustrated in the section view of FIG. 6) can function in a similar manner.

Accordingly, debris removal from degasser probe, according to the disclosure, can allow for a degasser probe having a rotatable worm screw to remove debris from a strainer screen of the degasser probe. The worm screw can cause debris caught by the strainer screen to be removed from the strainer screen more efficiently than previous approaches, reducing maintenance time and allowing for longer drilling operational periods, as compared with previous approaches. Further, devices to encourage axial flow of drilling fluid towards the strainer screen can increase the effectiveness of debris removal by the worm screw, as compared with previous approaches.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the disclosure.

It is to be understood that the above description has been made in an illustrative fashion, and not a restrictive one. Combination of the above embodiments, and other embodiments not specifically described herein will be apparent to those of skill in the art upon reviewing the above description.

The scope of the various embodiments of the disclosure includes any other applications in which the above structures and methods are used. Therefore, the scope of various embodiments of the disclosure should be determined with reference to the appended claims, along with the full range of equivalents to which such claims are entitled.

In the foregoing Detailed Description, various features are grouped together in example embodiments illustrated in the figures for the purpose of streamlining the disclosure. This method of disclosure is not to be interpreted as reflecting an intention that the embodiments of the disclosure require more features than are expressly recited in each claim.

Rather, as the following claims reflect, inventive subject matter lies in less than all features of a single disclosed embodiment. Thus, the following claims are hereby incorporated into the Detailed Description, with each claim standing on its own as a separate embodiment.

What is claimed:

1. A degasser probe, comprising:
a suction head configured to receive drilling fluid and cause the drilling fluid to be transmitted to a degasser during a drilling operation;
a strainer screen located upstream of the suction head and configured to filter the drilling fluid during the drilling operation; and
a worm screw located proximate to the strainer screen, wherein the worm screw is axially rotatable to remove debris from the strainer screen during the drilling operation.

2. The degasser probe of claim 1, further comprising an annular bumper connected to the suction head, wherein the annular bumper is configured to axially direct the drilling fluid towards the strainer screen during the drilling operation.

3. The degasser probe of claim 2, wherein the annular bumper:
radially encompasses the worm screw; and
axially encompasses the worm screw.

4. The degasser probe of claim 2, wherein the annular bumper, the worm screw, the strainer screen, and the suction head are coaxially located with respect to each other.

5. The degasser probe of claim 2, wherein the annular bumper and the strainer screen are connected to the suction head via a plurality of fasteners.

6. The degasser probe of claim 1, wherein the worm screw is located upstream of the strainer screen.

7. A degasser probe, comprising:
a suction head configured to receive drilling fluid and cause the drilling fluid to be transmitted to a degasser during a drilling operation;
a strainer screen located coaxially with and upstream of the suction head, wherein the strainer screen is configured to filter the drilling fluid during the drilling operation;
a worm screw located coaxially with and upstream of the strainer screen, wherein the worm screw is axially rotatable to remove debris from the strainer screen during the drilling operation; and
an annular bumper located coaxially with and upstream of the strainer screen, wherein the annular bumper is configured to axially direct the drilling fluid towards the strainer screen during the drilling operation.

8. The degasser probe of claim 7, wherein the worm screw comprises:
a central body having an outer surface, an inner surface, a first end surface, and a second end surface, wherein:
the first end surface is located proximate to the strainer screen;
the inner surface defines an opening through the central body; and
a longitudinal axis of the central body runs through a center of the opening; and
a plurality of blades extending outwardly from the outer surface of the central body.

9. The degasser probe of claim 8, wherein each blade of the plurality of blades is flighted in a partial helix around the longitudinal axis such that each blade extends radially from the outer surface for less than a complete turn around the longitudinal axis.

10. The degasser probe of claim 8, wherein each blade of the plurality of blades collectively contact an entirety of the outer surface between the first end surface and the second end surface.

11. The degasser probe of claim 8, wherein:
the plurality of blades include a first blade and a second blade;
the first blade is flighted in a first partial helix;
the second blade is flighted in a second partial helix; and
the first partial helix and the second partial helix collectively form a partial double helix around the longitudinal axis, wherein the partial double helix is less than a complete turn around the longitudinal axis.

12. The degasser probe of claim 8, wherein:
the degasser probe further includes a drive shaft located in the opening through the central body, wherein the drive shaft is connected to a motor; and
the drive shaft is configured to cause the worm screw to rotate during the drilling operation.

13. A degasser system, comprising:
a degasser; and
a degasser probe, comprising:
a suction head configured to receive drilling fluid and cause the drilling fluid to be transmitted to the degasser during a drilling operation;
a strainer screen located coaxially with and upstream of the suction head, wherein the strainer screen is configured to filter the drilling fluid during the drilling operation;
a worm screw located coaxially with and upstream of the strainer screen, wherein:
the worm screw comprises a central body having an outer surface, a first end surface located proximate to the strainer screen, a second end surface, and a plurality of blades; and
the worm screw is axially rotatable about a longitudinal axis through the central body such that the plurality of blades are configured to remove debris from the strainer screen during the drilling operation; and
a protective cage located coaxially with and upstream of the strainer screen, wherein the protective cage is configured to axially direct the drilling fluid towards the strainer screen during the drilling operation.

14. The degasser system of claim 13, wherein each blade of the plurality of blades includes:
a first edge located proximate to the first end surface and the strainer screen; and
a second edge located proximate to the second end surface.

15. The degasser system of claim 14, wherein the worm screw is configured to axially rotate about the longitudinal axis during the drilling operation in a direction such that the first edge is a leading edge and the second edge is a trailing edge during rotation of the worm screw.

16. The degasser system of claim 15, wherein the first edge is configured to lift the debris from the strainer screen during the drilling operation.

17. The degasser system of claim 16, wherein the first edge is configured to lift the debris in a substantially axial direction along the longitudinal axis.

18. The degasser system of claim 13, wherein the protective cage is connected to an external radial edge portion of the suction head.

19. The degasser system of claim 13, wherein the protective cage extends in a direction along the longitudinal axis of the central body of the worm screw.

20. The degasser system of claim 19, wherein the protective cage comprises:
a non-perforated portion located proximate to the strainer screen configured to further axially direct the drilling fluid towards the strainer screen during the drilling operation; and
a perforated portion to pre-filter the drilling fluid before the drilling fluid reaches the strainer screen.
